(19) United States
(12) Patent Application Publication
(10) Pub. No.: US 2010/0067977 A1
(43) Pub. Date: Mar. 18, 2010

(54) FASTENER

(75) Inventor: Jeffrey C. Bishop, Derby (GB)

Correspondence Address: OLIFF & BERRIDGE, PLC, P.O. BOX 320850, ALEXANDRIA, VA, 22320-4850, US

(73) Assignee: Rolls-Royce PLC, London (GB)

(21) Appl. No.: 12/312,787

(22) PCT Filed: Dec. 17, 2007
(86) PCT No.: PCT/GB2007/004849

§ 371 Date: May 27, 2009

(30) Foreign Application Priority Data
Jan. 12, 2007 (GB) 0700568.9

(51) Int. Cl. E04B 1/19; B23P 11/00

(52) U.S. Cl. 403/171; 29/428

(57) ABSTRACT

Traditional nut and bolt fasteners are generally acceptable but will normally be over specified for particular applications. Thus, in situations where weight is important such traditional nut and bolt fasteners are not optimised. By providing a fastener in which splayed arms are created with ridges in respective receptor members and insert arm members it will be understood that multi point stabilised contact points for a nut are provided. Thus, the nut can move along the ridges defining a screw path for tightening of the fastener in use. The engagement between the receptor members and the insert arm members is typically through a slot forked end or a closed slot with the slots presenting the splayed arms perpendicular to each other in a cruciform configuration.

The present invention relates to fasteners and more particularly to bolt and stud assemblies having a thread upon which a nut can be secured in order to fasten the bolt or stud to a structure.

Traditional fasteners in the form of bolts and studs have comprised a threaded member incorporating a screw thread upon which nuts can be secured in use. These thread members are solid and cylindrical with the thread extending either completely along the length of the threaded member or a substantial part of that length. The threaded members as indicated are solid and formed from a metal such as steel or another appropriately robust material.

Bolts and studs have been used for generations and are particularly advantageous in view of their mechanical strength and simplicity whilst being able to provide robust fasteners in use. However, a solid bolt and nut is normally an excessively strong fastener for most situations. Alternatives to nuts and bolts such as adhesives and riveting are disadvantaged with the lack of ease of adjustment subsequent to installation. There are some situations where a lighter and cheaper fastener would be more appropriate and in particular with respect to weight conscious aeronautical applications and with respect to medical usage.

Aspects of the present invention provide a fastener comprising a fastener characterised by comprising at least two interlocking plate members, at least one of the plate members defining a thread suitable for receiving a nut for securing the fastener.

Preferably, the plate members define splayed arms extending radially from a central axis, the splayed arms including ridges which define upon outer edges of the arms a screw path for a nut in use.

Typically, the splayed arms have a cruciform cross section.

Generally, the splayed arms extend for a portion of the length of the threaded member from one or more ends. Possibly, the splayed arms extend for substantially the whole length of the threaded member.

Generally, the splayed arms are provided by a receptor member having a forked end with a slot and an insert arm member for location within the slot of the forked end. Generally, the insert arm member has a lock association with the receptor member. Possibly, the receptor member is substantially flat. Possibly, the receptor member is angular or bent. Possibly, the receptor member is formed from a material bendable in use. Possibly, parts of the forked end are bendable to capture a nut in use.

Possibly, the receptor member includes a closed slot to receive the insert arm member. Possibly, the insert arm member has a stabiliser to act as a retainer in the closed slot.

Possibly, the insert arm member has grip features to engage the forked end. Possibly, the insert arm member is compressed in use into engagement by a nut. Possibly, the engagement is retained if the nut is removed. Possibly, the engagement provides a witness feature to indicate fastener use and/or the extent of nut travel in use.

Possibly, the insert arm member is tapered.

Possibly, the threaded member has a bolt end.

Generally, the threaded member is formed from a metal material such as steel.

Also in accordance with aspects of the present invention there is provided a method of forming a fastener comprising forming a threaded member having a screw path for a nut in use, the method characterised in that the threaded member comprises forming a receptor member having a forked end and ridges upon outer edges of the receptor member, forming an insert arm member for location within the forked end whereby the ridges on at least the outer edge of the receptor member define the screw path for a nut.

Generally, the method also provides forming ridges in the insert arm member for consistency with the ridges in the receptor member to define the screw path.

Typically, the receptor member is formed by laser cutting a substantially flat member.

Generally, the insert arm member is formed by a laser cutting process.

Possibly, the insert arm member is formed from a plastics material.

Possibly, the threaded member incorporates an aperture for a retainer member. Possibly, the retainer member comprises a pin or wire extending through the threaded member to prevent release of a nut in use.

Also in accordance with the present invention there is provided a fastener assembly comprising a fastener as described above and a nut.

Embodiments of the present invention will now be described by way of example and with reference to the accompanying drawings in which:

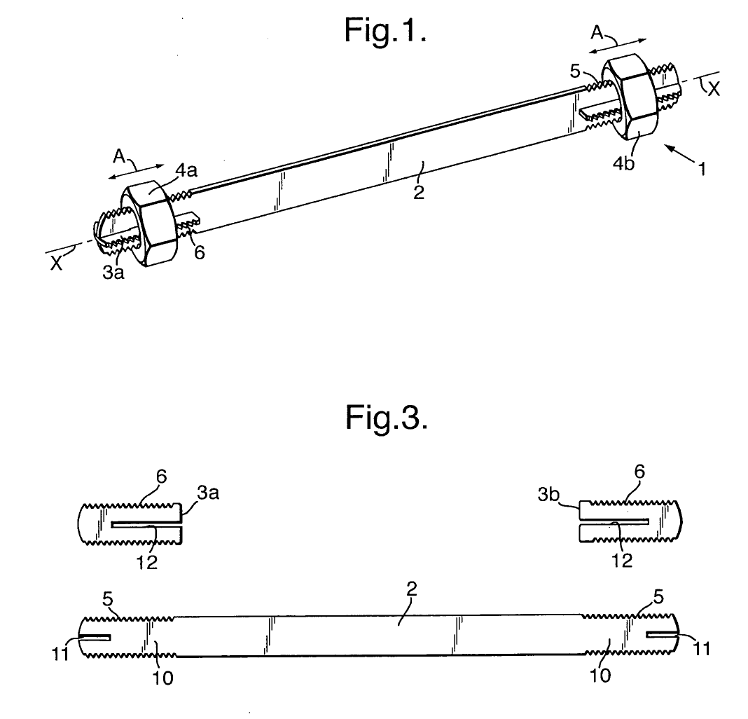

FIG. 1 provides a front perspective view of a first embodiment of a fastener in accordance with aspects of the present invention in the form of a stud assembly;

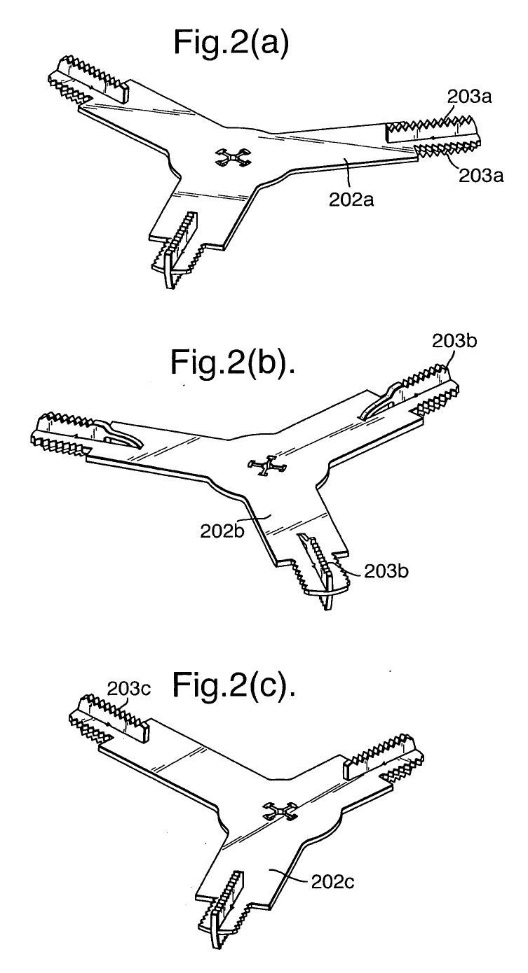

FIG. 2 provides a perspective illustration of non-linear fasteners in accordance with aspects of the present invention;

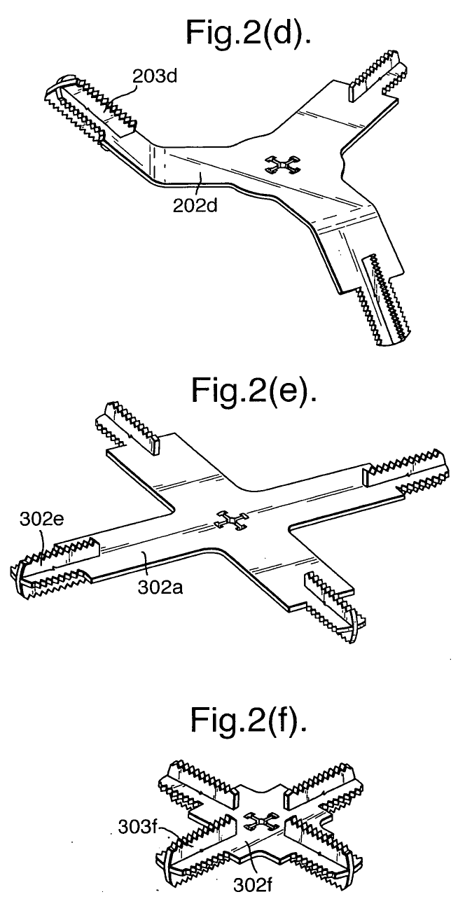

FIG. 3 illustrates a receptor member and insert arm members utilised in order to form the first embodiment of aspects of the present invention as depicted in FIG. 1;

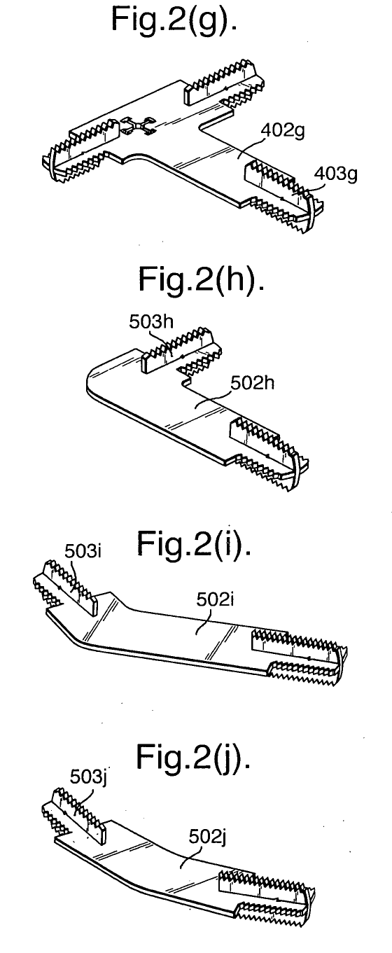

FIG. 4 provides a front perspective view of a second embodiment of a fastener in the form of a bolt assembly;

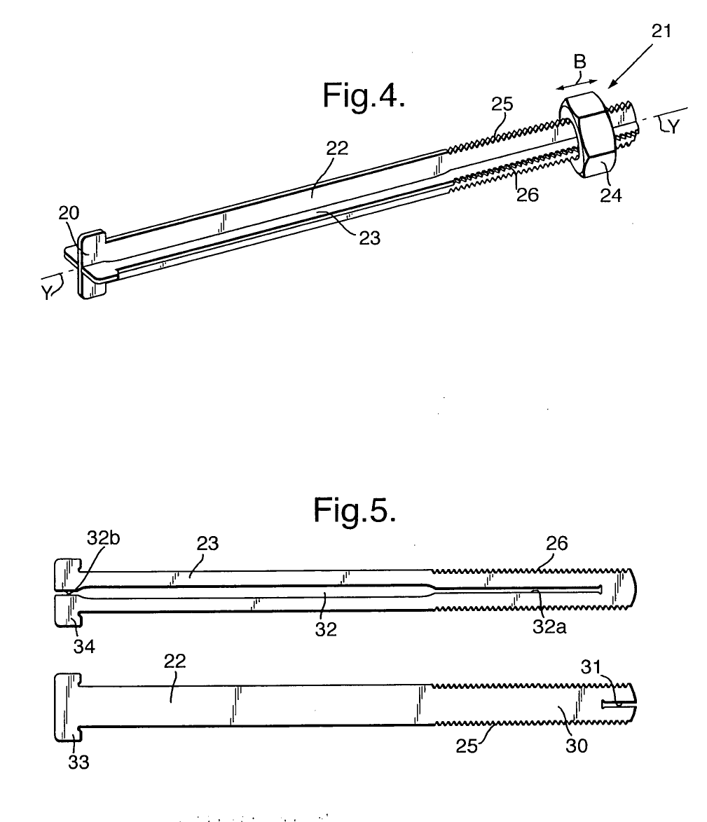

FIG. 5 illustrates a receptor member and insert arm members utilised in order to form the second embodiment of the present invention as depicted in FIG. 4.

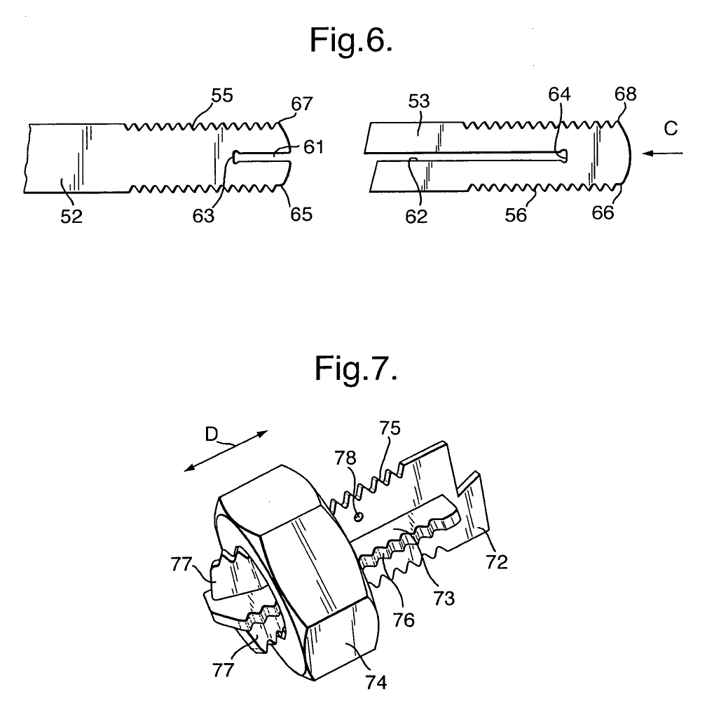

FIG. 6 is a schematic front view of a receptor and insert arm member in accordance with aspects of the present invention in greater detail;

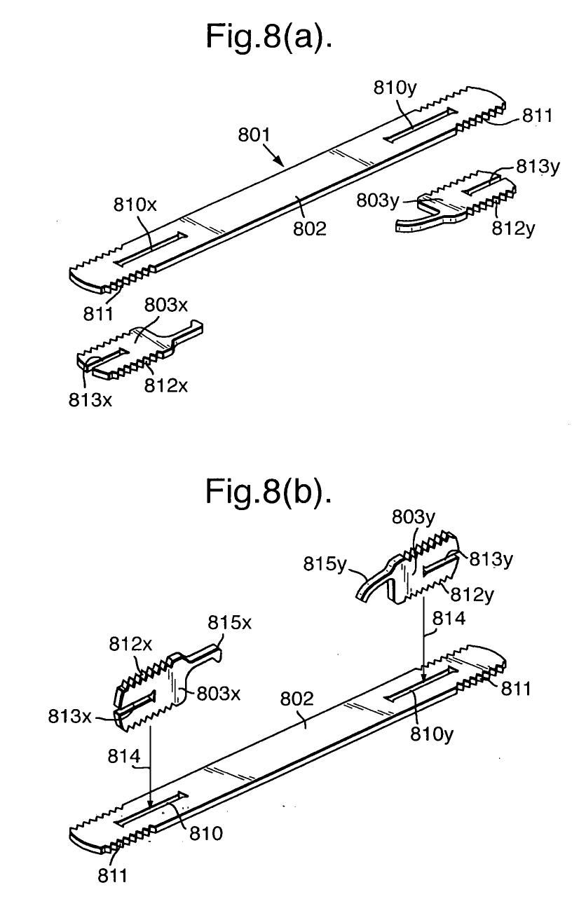

FIG. 7 is a perspective view of a receptor and insert arm end upon the end of a threaded member in accordance with aspects of the present invention; and,

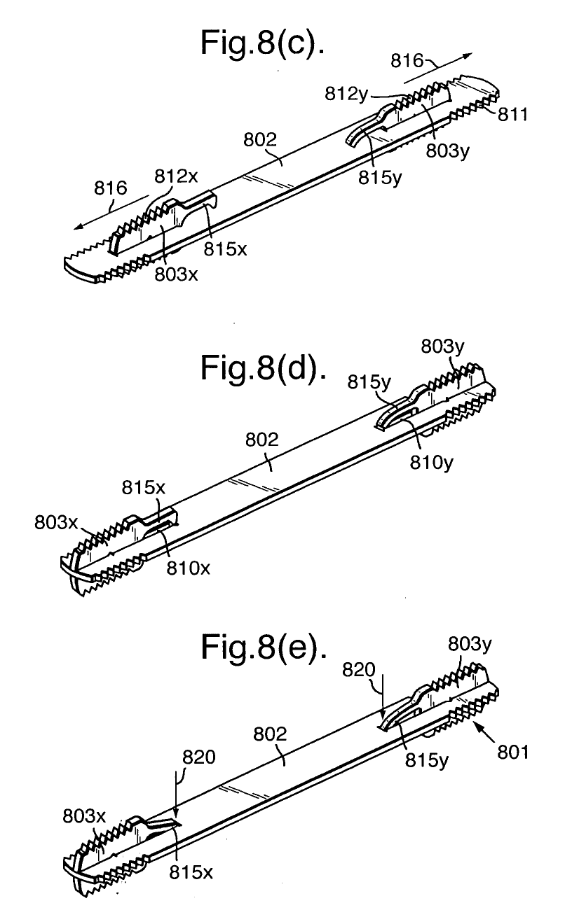

FIG. 8 illustrates the assembly steps with regard to a captive fastener in accordance with aspects of the present invention.

As indicated above, traditional nut and bolt arrangements to provide fasteners are well established and generally acceptable although not optimised for situations where in particular weight is a factor. It is also commonplace that such nut and bolt arrangements are over specified in terms of their capabilities for the actions required. In such circumstances nuts and bolts can have difficulties in terms of acceptability for use.

In accordance with aspects of the present invention a splayed arm fastener is provided in which the splayed arms extend radially from a major (central) axis of a threaded member. The splayed arms are provided along outer edges with ridges or grooves which define a screw path for a nut in use. Typically, the splayed arms are in a cruciform configuration for convenience of assembly but, where possible or necessary, three splayed arms may be provided or more than four splayed arms provided such that at least some of the splayed arms define ridges which can then provide a screw path for a nut in use. Generally, it is most convenient that the splayed arms are opposite to each other for balance as a nut is presented and screwed along the screw path. As indicated, a splayed arm cruciform, that is to say four splayed arms is most convenient.

FIGS. 1 to 4 illustrate respectively two alternative embodiments of a fastener 1; 21 in accordance with aspects of the present invention. FIGS. 1 and 2 illustrate a first embodiment in a stud configuration of fastener 1 in accordance with aspects of the present invention. FIGS. 3 and 4 illustrate a second embodiment in a bolt configuration of a fastener 21 in accordance with aspects of the present invention.

The splayed arms as indicated extend radially from a major axis of the fastener although the fastener may be bent and therefore this axis is more typically the centre of the fastener member. The splayed arms are formed from flat members typically cut by a laser process to incorporate a forked end in a receptor member with an insert arm mounted in a slot of that forked end for appropriate location. Normally, both the receptor member and the insert arm member will incorporate ridges in the radially extending edges to define the screw path. However, as will be described later, most of the tensile force is presented through the receptor member when using the fastener.

FIG. 1 illustrates a first embodiment of a fastener in accordance with aspects of the present invention in the form of a stud assembly. Thus, the fastener 1 comprises a receptor member 2 with insert arm members 3 at each end. Nuts 4 are located at each end and generally move along a screw path defined by ridges 5, 6 respectively in the receptor member 2 and the insert arm members 3. In such circumstances the nuts 4 can travel respectively in the direction of arrowheads A to tighten the fastener 1 in use. The ridges 5, 6, are formed upon outer edges radially displaced from the central line X-X.

As can be seen, the receptor member 2 and the insert arm members 3 are generally flat and enter each other through a forked end with a slot as will be described later with regard to FIG. 2. It will be appreciated that the weight of material utilised in forming the fastener 1 is significantly less than a similar sized fastener formed in a traditional fashion from a solid cylindrical fastener member extending to the same length with similar sized nuts 4. In such circumstances the fastener 1 has significant weight advantage and can be designed more specifically to required retention requirement in use. It will also be understood in some situations it will be necessary or desirable for the fastener to extend around bends and corners such that the receptor member 2 can be bent and shaped such that the ends are presented through apertures in a structure around a corner or bend in that structure with the screw paths created and the nuts secured upon those screw paths in order to retain the fastener in use.

FIG. 2 provides schematic illustrations as perspective views of fasteners having a non linear configuration in accordance with aspects of the present invention. Such non-linear configurations will allow the fasteners to extend around bends and corners to facilitate assembly of components in use. Thus, fasteners FIG. 2a, 2d illustrate three legged fasteners with each leg at a different angle radiating from a centre. Each fastener has a receptor member 202 to form the legs with insert arms 203 to form legs in a fastener in accordance with aspects of the present invention.

FIG. 2e and FIG. 2f illustrate cross configuration fasteners in accordance with aspects of the present invention in which again legs are formed by receptor members 302 with insert arms 303 to form fasteners in accordance with aspects of the present invention. Respective fasteners depicted in FIGS. 2e and 2f have different sizes and, as will be noted, the screw threads defined by the members 302, 303 have different lengths and portions with regard to the size of the fasteners depicted.

FIG. 2g depicts a fastener having a substantial T-cross section and, in a similar fashion to FIGS. 2a, 2d projects three arms outwardly but with a T configuration. Nevertheless, again receptor members 402 are utilised with insert arms 403 to define fasteners in accordance with aspects of the present invention.

It will be understood by appropriate shaping, particularly of the receptor member, bending and angling of a fastener in accordance with aspects of the present invention can be readily achieved. Thus, as depicted in FIGS. 2h, 2j shaped elongate members 502 have angles along their lengths to define with insert arms 503 fasteners in accordance with aspects of the present invention.

FIG. 3 illustrates the principal components in the fastener 1 depicted in FIG. 1. Thus, the receptor member 2 incorporates forked ends 10 each incorporating a slot 11. The slots 11 are engaged by slots 12 in the insert arm members 6 in use to present the screw path in the form of ridges 5, 6 in the respective members 2, 3 upon which a nut (not shown) is secured in use as depicted in FIG. 1.

The slots 11, 12 have a width to respectively accommodate generally snugly the respective members 2, 3 such that the splayed arms formed by the respective members 2, 3 are substantially perpendicular to each other and in a cruciform configuration. The slot 11 will generally be the width of the insert arm members 3 and the slot 12 will have a width generally the thickness of the receptor member 2 at the forked end 10.

When the insert arm members 3 are secured upon the forked ends 10, it will be appreciated that this association will generally be maintained by the nuts 4 in use.

FIG. 4 provides a perspective view of a second embodiment of a fastener 21 in accordance with aspects of the present invention in the form of a bolt assembly. Thus, the fastener 21 is similar to that depicted in FIG. 1 except that a bolt end 20 is provided formed by respective parts of a receptor member 22 and an insert arm member 23. As previously, the members 22, 23 define splayed arms with radial outer edges radially displaced from a central line Y-Y and having ridges 25, 26 to form a screw path for a nut 24. The nut 24 can move along the screw path defined by the ridges 25, 26 in the direction of arrowheads B to tighten or loosen the fastener 21 in use. This movement in the direction of arrowheads B is generally to tighten and loosen against the bolt end 20 in use.

The bolt end 20 comprises upstanding radially extending lugs from a major longitudinal axis Y-Y of the fastener 21. In such circumstances it will be appreciated in use the members 22, 23 will extend through an aperture in a structure such that the upstanding lugs or tabs of the bolt end 20 engage against one side of that aperture whilst the nut 24 engages against other parts of that structure or secures another component to the structure in a typical nut and bolt type configuration.

FIG. 5 illustrates the principal components of the fastener 21 depicted in FIG. 3. Thus the receptor member incorporates a forked end 30 in which a slot 31 is provided and is engaged by a similar slot 32 in the insert arm member 23. In such circumstances when assembled, as indicated previously, the ridges 25, 26 are substantially presented in splayed arms in a perpendicular relationship in order to define a screw path upon which a nut (not shown) can move in order to tighten against tabs or lugs 33, 34 which extend radially.

The slots 31, 32 particularly in a portion 32a are shaped and sized for appropriate presentation of radially extending parts of the members 22, 23 in a splayed arm cruciform configuration. The members 22, 23 may be secured together through an adhesive but generally in use the nut acting about the ridges 25, 26 will ensure appropriate retention of the association between the members 22, 23. The lugs or tabs 33, 34 may be secured to each other or a simple constriction 32b provided to provide some orientation between the tabs 33, 34 but generally engagement by radially extending parts of the tabs 33, 34 with an aperture will ensure retention in use.

As indicated above, generally the receptor member 2, 22 will be subject to most tensile stressing and therefore will require to be formed from appropriately robust materials such as metals. Particularly in the stud assembly configuration depicted in FIG. 1 as indicated it will be the receptor member 2 which is subject to tensile load. In such circumstances the insert arm member provides a potential four point stabilised concentric rotation for the nut 4 during a tightening sequence, that is to say the members 3, 23 ensure the nut is appropriately presented to the ridges 5, 6; 25, 26 for tightening.

It will be appreciated whether a stud configuration, as depicted in FIG. 1, or a bolt configuration as depicted in FIG. 3, is utilised will be dependent upon design requirements.

The members 2, 3 can be formed by an appropriate laser cutting process from a flat component. The flat area between the ends can be profiled, slotted and shaped as appropriate by laser cutting techniques.

As indicated above, being relatively flat components the members 2, 3; 22, 23 will allow use of techniques such as laser cutting which are inappropriate for curved and solid/forged fastener members as utilised in a conventional bolt configuration.

FIG. 5 illustrates in greater detail association between a receptor member 52 and an insert arm member 53 in accordance with aspects of the present invention. It will be appreciated in use the members 52, 53 will be rotated to be substantially perpendicular to each other so that slots 61, 62 will engage each other. As indicated previously, the width of the slots 61, 62 will generally be such that there is perpendicular presentation of the members 52, 53 in use. The ends 63, 64 of the slots 61, 62 are generally shaped to provide abutment in use and arrest any ripple crack propagation due to the tensile and compressive forces created.

It will be understood that dependent upon requirements a left hand or right hand screw path may be appropriate. In such circumstances, as can be seen, the respective members 52, 53 have shoulders 65, 66 and screw path initiation points 67, 68. The position of the shoulders 65, 66 as well as the screw path initiation points 67, 68 will provide perpendicular contact points for a nut (not shown) upon initial presentation to a fastener in accordance with aspects of the present invention. As indicated previously, the combination of the members 52, 53 and ridges 55, 56 provides a stabilised four point contact screw path helix along the length of the fastener for engagement by the nut. In such circumstances the shoulders 65, 66 as well as points 67, 68 will be accurately positioned to enable the nut to be located in use. It will be appreciated once the nut has initiated concentric axis rotation along the ridges 55, 56 appropriate adjustment of the members 52, 53 by relative slide movement in the slots 62, 63 may be achieved. In such circumstances initially some flexibility with regard to presentation of a nut is desirable with some wiggling or other action possible to enable the nut to be initially located about the shoulders 65, 66 and points 67, 68.

On assembly it will be appreciated that the insert arm member 53 will move in the direction of arrowheads C to force engagement between the slots 61, 62. The depth of the slots 61, 62 will be accurately determined such that on assembly the shoulders 65, 66 and points 67, 68 are substantially in the screw path configuration required.

As indicated, right hand and left hand screw thread paths can be achieved. Choice of the right hand or left hand screw path can be achieved through appropriate configuration of the shoulders 66 and points 68 in the insert arm member 53. In one configuration with the member 53 in a 90° rotation it will be appreciated that one screw thread direction will be achieved whilst turning the member 53 in the other direction by 90° , a 180° difference will achieve the other screw thread configuration. Thus, fasteners in accordance with aspects of the present invention can provide both left and right hand screw thread paths electively.

FIG. 8 provides schematic perspective illustrations of assembly stages with regard to forming a captive fastener in accordance with aspects of the present invention. It will be appreciated that the fasteners described above generally have an open ended fork aspect to the receptor members within which the insert arms are secured. An alternative is to create a closed slot in the receptor member within which the insert arm is secured.

FIG. 8a illustrates the components of a captive fastener in accordance with aspects of the present invention. Thus, a receptor member 802 incorporates a closed slot 810 and screw thread ridges 811 whilst insert arms 803 also have screw thread ridges 812 and a splay slot 813. These members 802, 803 are generally formed as described previously by an appropriate cutting process such as from a sheet of material.

As depicted in FIG. 8b the members 803 are presented to the receptor member 802 such that movement in a vertical direction depicted by arrowheads 814 results in location of the members 803 in the slots 810. As can be seen, the member 803 incorporates stabilising fasteners 815 which upon assembly, as depicted in FIG. 8c, engage a surface of the receptor member 802. The stabilisers 815 generally provide for location such that by a lateral movement in the direction of arrowheads 816 the insert arm members 803 can be located as depicted in FIG. 8d. In such circumstances, the splay slot 813 passes over the member 802 in order to appropriately present the arm member 803 within the receptor member 802.

As can be seen in FIG. 8d, the insert arm member 803 generally has an end consistent with the end of the receptor member 802 in order that the ridges 811, 812 can be configured to define a screw thread path for a fastener in accordance with aspects of the present invention. In this configuration depicted in FIG. 8d, the stabiliser just extends beyond the end of the slot 810. In order to stabilise and retain the fastener configuration as depicted in FIG. 8e an end of the stabiliser 815 is depressed and is distorted downwardly in the direction of arrowheads 820 such that the positions of the members 803 are relative to the receptor member 802 is retained in order to present the ridges 811, 812 as a screw thread path for a nut in accordance with aspects of the present invention.

In the above circumstances it will be appreciated that a robust fastener is provided by the captive configuration in accordance with aspects of the present invention depicted in FIG. 8.

As indicated above fasteners in accordance with the present invention will utilise a nut to provide retention. In some circumstances the ability to lock that nut in position will be advantageous. In FIG. 6 a perspective view of one approach to locking a nut 74 in position is depicted. As previously, a receptor member 72 is engaged by an insert arm member 73 such that splayed arms are provided with ridges 75, 76 upon which the nut 74 is secured. The nut 74 can move along the ridges 75, 76 which define a thread path as described previously in the direction of arrowheads D. In such circumstances in use the nut 74 can be moved along the ridges 75, 76 to an extent desirable in order to provide an appropriate retention by a fastener in accordance with aspects of the present invention. Once an appropriate position for the nut 74 has been achieved, in accordance with the embodiment depicted in FIG. 6, ends 77 of the forked end will be distorted generally in opposite directions as depicted to prevent reverse movement of the nut 74 along the ridges 75, 76 to release position. In such circumstances the nut 74 is then held in position and locked in that position.

It will be understood where desirable, and most normally in the receptor member 72, holes 78 may be provided on either or one side of the nut 74. These holes 78 may accommodate a split pin or wire with security tag if required to limit movement of the nut 74 in use.

In the above circumstances lock mechanisms are provided for the nut 74. Where the ends 77 of the receptor member 72 are deformed typically that deformation will be in the direction of undoing for the nut 74.

By aspects of the present invention it will be appreciated that a fastener is provided which can be of a lighter weight and has a lower manufacturing cost than previous traditional nut and bolt fasteners. Furthermore, formation of an appropriate fastener for particular usage can be more readily achieved and alteration between a left hand and right hand thread path more readily provided in use. Through the nature of the receptor members and insert arm members it will be understood that bending and shaping of the fastener can be more readily achieved than previous substantially cylindrical bolt configurations. It will also be understood that through provision of a forked end parts of these ends can be bent and formed to provide an in situ locking mechanism which can also act as an anti rotation feature useful in some situations. The splayed arms formed by the radially extending parts of the receptor members and insert arm members as illustrated in FIG. 3 can extend substantially the whole length of the fastener or only at ends as depicted in FIG. 1. Furthermore, the ridges provided to define the screw paths may extend along the whole or part of the radially splayed arms provided by the receptor member and the insert arm members.

As indicated above, generally the receptor members and insert arm members will be associated with each other through appropriate slots. The turning of a nut upon the ridges may act to compress the association between the receptor member and the insert arm member forcing a gripping action between the receptor member and the insert arm member. This may be facilitated by appropriate grip features in the slots of the respective receptor members and insert arm members. This grip engagement as indicated may be created by the nut moving along the screw path created by ridges. The grip engagement may be retained once the nut is removed by the grip elements in the slots embedding in the material of the opposed receptor member or insert arm member. It will be appreciated even where the grip engagement is not retained the action of the gripper members or other engagements may provide a witness feature to indicate that the fastener has been used and/or possibly the extent of nut travel along the screw path created by the ridges in the respective receptor members and/or insert arm members. The compressive engagement may be facilitated by slight tapering in the receptor member and/or insert arm member such that the notional screw path diameter increases slightly as the nut moves along the screw path provided to causing compression. It will also be understood that the slots may be slightly tapering again to increase the resistance to further movement of the nut along the screw path.

A fastener in accordance with aspects of the present invention will be made by cutting or otherwise forming receptor members and insert arm members from typically a flat sheet material. Generally that sheet material will be of metal, but as indicated particularly with regard to stud configurations, it may be possible for the insert arm members to be made from a less robust material such as a plastic provided sufficient stabilised presentation of the nut is achieved upon the ridges of the receptor member in use to allow an appropriately consistent screw path to be determined and utilised by the nut. The receptor members and insert arm members may be cut through an appropriate laser process to define the fork ends, ridges and slots as required in order to provide upon assembly appropriate presentation of splayed arms with ridges to define screw paths for a nut in use. The size and positioning of the ridges as indicated will depend upon the nut to be secured upon the fastener in use in terms of its gauge. Thus, as indicated, initially the substantially flat receptor members and insert arm members will be created and then assembled. The length particularly of the receptor members will be determined by the installation and operational requirements of the fastener in use. As indicated, the receptor member in particular can be bent to accommodate operational requirements.

Fasteners in accordance with aspects of the present invention as indicated have a potentially relatively lightweight structure in comparison with traditional nut and bolt fastener arrangements. Thus, fasteners in accordance with aspects of the present invention may have particular applicability with regard to weight conscious environments such as those appropriate with aeronautical or medical applications.

Lightweight surgical bone implants require torsional flexibility, stability, adhesive friendly profiles and tensile compaction capabilities. A cruciform cross section in accordance with the preferred embodiment of aspects of the invention as described above occupies a smaller volume than a cylindrical bolt profile and therefore reduces any effects of localised bone marrow reduction upon implant. Such an approach may lead to permanent retention of an otherwise transient prosthesis and so avoid any further intrusive surgery. It will also be understood the configuration of a fastener with flat surfaces particularly with regard to medical applications will allow those surfaces to be further enhanced for body repair. It will also be understood that it may be possible to provide short term emergency prosthesis with fasteners in accordance with aspects of the present invention by appropriate bending and shaping of the receptor members in particular to requirements.

As fasteners in accordance with aspects of the present invention will utilise generally less material volume, it will be understood that the acceptability of unusual and possibly high cost materials for forming fasteners may be more acceptable.

Modifications and alterations to the embodiments of the present invention as described above will be appreciated by those skilled in the art. Thus, as indicated the fastener may be formed from a metal or plastic material with the slots for association between the receptor member and the insert arm members to create the splayed arms adapted and adjusted for particular requirements. Although a cruciform configuration is preferred, it will be appreciated that where possible six splayed arms may be provided by a receptor member accepting two insert arm members into a forked end equally spaced in order to create six splayed arms upon which ridges are provided in order to create screw paths for a nut in use.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-31. (canceled)

32. A fastener comprising at least two interlocking plate members that slot together, at least one of the plate members defining a thread suitable for receiving a nut for securing the fastener.

33. A fastener as claimed in claim 32 wherein the plate members define splayed arms extending radially from a central axis, the splayed arms including ridges which define upon outer edges of the arms a screw path for a nut in use.

34. A fastener as claimed in claim 33 wherein the splayed arms have a cruciform cross section.

35. A fastener as claimed in claim 33 wherein the splayed arms extend for a portion of the length of the threaded member from one or more ends.

36. A fastener as claimed in claim 33 wherein the splayed arms are provided by a receptor member having a forked end with a slot and an insert arm member for location within the slot of the forked end.

37. A fastener as claimed in claim 36 wherein the insert arm member has a lock association with the receptor member.

38. A fastener as claimed in claim 36 wherein the receptor member is angular or bent.

39. A fastener as claimed in claim 36 wherein the insert arm member has grip features to engage the forked end.

40. A fastener as claimed in claim 32 wherein the fastener incorporates a receptor member having a closed slot to receive an insert arm member to define the splayed arms.

41. A fastener as claimed in claim 40 wherein the insert arm member having a forked slot to engage the closed slot.

42. A fastener as claimed in claim 41 wherein the insert arm incorporates a stabiliser to retain position of the insert arm within the closed slot.

43. A fastener as claimed in claim 36 wherein the insert arm member is tapered.

44. A fastener as claimed in claim 35 wherein the threaded member has a bolt end.

45. A fastener as claimed in claim 35 wherein the threaded member incorporates an aperture for a retainer member.

46. A method of assembling a fastener as claimed in claim 32 comprising the steps of slotting together the at least two interlocking plate members and threading the nut onto at least one of the plate members that defines the thread to secure the fastener.
